(19) United States
(12) Patent Application Publication
(10) Pub. No.: US 2013/0164705 A1
(43) Pub. Date: Jun. 27, 2013

(54) CLEANING DEVICE FOR ORAL CAVITY

(71) Applicants: Toshio Tanaka, Sakai-shi (JP); Kenkichi Kagawa, Sakai-shi (JP); Makoto Iwakame, Settsu-shi (JP); Mitsuji Ohgami, Settsu-shi (JP); Takanori Ijitsu, Ashigarakami-gun (JP); Shinichi Takahira, Tokyo (JP); Eriko Ooshima, Tokyo (JP)

(72) Inventors: Toshio Tanaka, Sakai-shi (JP); Kenkichi Kagawa, Sakai-shi (JP); Makoto Iwakame, Settsu-shi (JP); Mitsuji Ohgami, Settsu-shi (JP); Takanori Ijitsu, Ashigarakami-gun (JP); Shinichi Takahira, Tokyo (JP); Eriko Ooshima, Tokyo (JP)

(73) Assignees: TERUMO KABUSHIKI KAISHA, Tokyo (JP); DAIKIN INDUSTRIES, LTD., Osaka-shi, Osaka (JP)

(21) Appl. No.: 13/821,740

(22) PCT Filed: Sep. 15, 2011
(86) PCT No.: PCT/JP2011/005212

§ 371 Date: Mar. 8, 2013

(30) Foreign Application Priority Data
Sep. 16, 2010 (JP) 2010-207970

(51) Int. Cl. A61C 1/00; A61C 19/06; A61C 17/02

(52) U.S. Cl. CPC A61C 1/0084; A61C 17/0202; A61C 17/0208; A61C 19/066
USPC 433/82; 433/80

(57) ABSTRACT

An oral cleaning device includes: a wash water production tank in which wash water to be fed into an oral cavity is produced and stored; a water feed mechanism including a water feed channel having one end connected to the wash water production tank, a carrier configured to carry the wash water in the wash water production tank into the water feed channel, and a release unit connected to an outlet end of the water feed channel to release the wash water into the oral cavity; and an electrical discharge generator which includes a pair of electrodes for inducing streamer discharge in water, and a power supply configured to apply a voltage to the pair of electrodes, and is configured to produce hydrogen peroxide in the water by the streamer discharge.

### TECHNICAL FIELD

The present invention relates to oral cleaning devices for cleaning the inside of an oral cavity.

### BACKGROUND ART

Oral cleaning devices for cleaning the inside of an oral cavity have been conventionally known. For example, an oral cleaning device described in PATENT DOCUMENT 1 includes a tank, a tube connected to the tank, a pump connected to the tube, and a cleaning head connected to an outlet end of the tube. Predetermined wash water is produced and stored in the tank, e.g., to clean and sterilize the inside of an oral cavity. The cleaning head is made of a porous material with high water permeability.

When the pump is driven, the wash water in the tank is fed through the tube to the cleaning head. The wash water fed to the cleaning head is released through a plurality of outlets into an oral cavity. As a result, the wash water is fed into the oral cavity to clean and sterilize the inside of the oral cavity.

### CITATION LIST

### Patent Document

PATENT DOCUMENT 1: Japanese Patent Publication No. 2008-119147

### SUMMARY OF THE INVENTION

### Technical Problem

In order to enhance the effectiveness of oral cleaning, wash water containing hydrogen peroxide may be used for such an oral cleaning device as described above. However, hydrogen peroxide is unstable, and thus, when wash water with the effectiveness of oral cleaning is to be used, wash water containing a predetermined concentration of hydrogen peroxide needs to be prepared, and needs to be added into the tank as appropriate. Alternatively, hydrogen peroxide may be produced, for example, by electrolyzing water in the tank. However, a method in which hydrogen peroxide is produced by electrolysis provides insufficient hydrogen peroxide producing potential, and thus, it is very difficult to obtain wash water containing a predetermined concentration of hydrogen peroxide.

It is therefore an object of the present invention to provide an oral cleaning device enabling easy production of wash water having a high degree of effectiveness of oral cleaning and containing hydrogen peroxide.

### Solution of the Problem

A first aspect of the invention is directed to an oral cleaning device, and the oral cleaning device includes: a wash water production tank (20) in which wash water to be fed into an oral cavity is produced and stored; a water feed mechanism (30) including a water feed channel (31) having one end connected to the wash water production tank (20), a carrier (32) configured to carry the wash water in the wash water production tank (20) into the water feed channel (31), and a release unit (33, 90, 95) connected to an outlet end of the water feed channel (31) to release the wash water into the or al cavity; and an electrical discharge generator (50) which includes a pair of electrodes (51, 52) for inducing streamer discharge in water in the wash water production tank (20), and a power supply (65) configured to apply a voltage to the pair of electrodes (51, 52), and is configured to produce hydrogen peroxide in the water by the streamer discharge.

According to the first aspect of the invention, streamer discharge is performed in water by applying a voltage from the power supply (65) of the electrical discharge generator (50) to the pair of electrodes (51, 52). When streamer discharge is performed, active species, such as hydroxyl radicals, are produced in the water. The active species react with water molecules to produce a large amount of hydrogen peroxide. As a result, wash water containing hydrogen peroxide is easily obtained in the wash water production tank (20). The wash water in the wash water production tank (20) is carried from the wash water production tank (20) into the water feed channel (31) by the carrier (32). The wash water flowing through the water feed channel (31) is fed through the release unit (33, 90, 95) into the user's oral cavity. As a result, the inside of the oral cavity is cleaned and sterilized.

According to a second aspect of the invention, in the first aspect of the invention, the power supply (65) may be a direct-current power supply (65) configured to apply a direct-current voltage to the pair of electrodes (51, 52), and the electrical discharge generator (50) may include a current density concentration member (55) configured to increase a current density in a current path between the pair of electrodes (51, 52).

According to the second aspect of the invention, streamer discharge is performed between the pair of electrodes (51, 52) by applying a direct-current voltage from the direct-current power supply (65) to the pair of electrodes (51, 52). In contrast, when a direct-current voltage is applied to the pair of electrodes (51, 52) as above, the leakage current between the pair of electrodes (51, 52) is larger than, e.g., when a pulse voltage is applied thereto, and thus, it becomes difficult to perform electrical discharge. To address this problem, the electrical discharge generator (50) of the second aspect of the invention includes the current density concentration member (55) configured to increase the current density between the pair of electrodes (51, 52). The current density concentration member (55) increases the current density between the pair of electrodes (51, 52), and thus, also when a direct-current power supply is used as the power supply (65), electrical discharge can be performed.

According to a third aspect of the invention, in the first or second aspect of the invention, the release unit (33) may include a main body (34) having an outlet (36) through which the wash water is released, and a brush (35) formed on a surface of the main body (34).

In the release unit (33) of the third aspect of the invention, the brush (35) is formed on the surface of the main body (34). The wash water is fed through the outlet (36) of the main body (34) into the user's oral cavity. In this case, the user can brush, e.g., the inside of the oral cavity and teeth using the brush (35).

According to a fourth aspect of the invention, in any one of the first through third aspects of the invention, the release unit (95) may include a spray (95) configured to spray the wash water.

According to the fourth aspect of the invention, the wash water is fed in the form of mist through the spray (95) into the oral cavity. Thus, the wash water is relatively widely and uniformly fed into the oral cavity.

According to a fifth aspect of the invention, in any one of the first through fourth aspects of the invention, the oral cleaning device may further include: a drain mechanism (40) including a suction unit (41) configured to suction the wash water in the oral cavity and discharge the wash water to an outside.

According to the fifth aspect of the invention, the wash water utilized to clean and sterilize the inside of the oral cavity is suctioned into the suction unit (41), and discharged to outside the oral cavity.

According to a sixth aspect of the invention, in the fifth aspect of the invention, the oral cleaning device may further include: a controller (70) configured to control the water feed mechanism (30) and the drain mechanism (40) to alternately perform a water feed operation in which the wash water is fed into the oral cavity and a drain operation in which the wash water is discharged from an inside of the oral cavity each for a predetermined time, or to simultaneously perform the water feed operation and the drain operation.

According to the sixth aspect of the invention, the water feed mechanism (30) and the drain mechanism (40) are controlled by the controller (70) to alternately perform the water feed operation and the drain operation each for a predetermined time, or to simultaneously perform the water feed operation and the drain operation.

When alternately performing the water feed operation and the drain operation, if, for example, the water feed operation is first performed, the wash water is fed through the release unit (33, 90, 95) into the oral cavity. Thereafter, with the completion of the water feed operation, the drain operation is performed, and the wash water in the oral cavity is suctioned into the suction unit (41), and discharged to outside the oral cavity. With the completion of the drain operation, a water feed operation is again performed.

When the water feed operation and the drain operation are simultaneously performed, the wash water is fed through the release unit (33, 90, 95) into the oral cavity, and simultaneously, the wash water in the oral cavity is suctioned into the suction unit (41), and discharged to outside the oral cavity.

According to a seventh aspect of the invention, in any one of the second through sixth aspects of the invention, the current density concentration member (55) may be formed as an insulative container having at least one opening (58), and may surround only one (51) of the pair of electrodes (51, 52).

According to the seventh aspect of the invention, the electrode (51) is housed in the current density concentration member (55) formed as an insulative container. Since at least one opening (58) is formed in the current density concentration member (55), an electrical discharge path is formed between the pair of electrodes (51, 52) to pass through the opening (58). A current path between the pair of electrodes (51, 52) is narrowed by the opening (58), and thus, the current density is concentrated in the vicinity of the opening (58). As a result, stable streamer discharge is performed through the opening (58) between the pair of electrodes (51, 52).

According to an eighth aspect of the invention, in any one of the first through seventh aspects of the invention, in the water feed mechanism (30), a junction tank (80) may be connected to the water feed channel (31) between the wash water production tank (20) and the release unit (33, 90, 95).

According to the eighth aspect of the invention, the junction tank (80) is provided between the wash water production tank (20) and the release unit (33, 90, 95). When the junction tank (80) is provided as above, the type of wash water can be changed, for example, by feeding another type of wash water into the junction tank (80).

### Advantages of the Invention

According to the present invention, streamer discharge is performed in water in the wash water production tank (20) to produce hydrogen peroxide. This eliminates the need for appropriately adding a hydrogen peroxide solution into the wash water production tank (20), and wash water containing hydrogen peroxide can be easily obtained. The streamer discharge of the present invention allows the rate of production of hydrogen peroxide to be much higher than that through, e.g., electrolysis. Therefore, a large amount of hydrogen peroxide is produced in a short time, thereby enhancing the effectiveness of oral cleaning and oral sterilization.

According to the second aspect of the invention, the direct-current power supply (65) is used as the power supply of the electrical discharge generator (50). This can provide a simpler power supply having a smaller size at lower cost than when a known pulse power supply is used. The use of such a pulse power supply tends to increase the intensity of a shock wave and noise in water due to electrical discharge; however, the use of the direct-current power supply (65) can reduce such a shock wave and noise.

Furthermore, according to the second aspect of the invention, since the electrical discharge generator (50) includes the current density concentration member (55), the direct-current power supply (65) also enables stable streamer discharge in water. Therefore, hydrogen peroxide can be stably produced in the wash water production tank (20).

According to the third aspect of the invention, since the release unit (33) includes the brush (35), a biofilm or plaque deposited on the inside of the oral cavity, for example, can be removed using the brush (35).

According to the fourth aspect of the invention, since wash water is fed in the form of mist through the spray (95) into the oral cavity, the wash water can be widely and uniformly fed into the oral cavity. This can further enhance t he effectiveness of oral cleaning and oral sterilization.

According to the fifth aspect of the invention, the wash water utilized to clean and sterilize the inside of the oral cavity can be discharged to outside the oral cavity. This can prevent the wash water accumulated in the oral cavity from overflowing the oral cavity.

According to the sixth aspect of the invention, the water feed operation in which the wash water is fed into the oral cavity, and the drain operation in which the wash water is discharged from the inside of the oral cavity are alternately performed. Therefore, the wash water in the oral cavity can be sequentially replaced, thereby further enhancing the effectiveness of oral cleaning and oral sterilization. Furthermore, in the present invention, when the water feed operation and the drain operation are simultaneously performed, this can prevent the amount of the wash water in the oral cavity from being too large.

According to the seventh aspect of the invention, one of the pair of electrodes (51, 52) is surrounded by the current density concentration member (55) formed as an insulative container, and thus, the opening (58) narrows the current path. This can increase the current density in the vicinity of the opening (58), thereby providing stable streamer discharge to produce hydrogen peroxide.

According to the eighth aspect of the invention, since the water feed channel (30) includes the junction tank (80), another type of wash water can be added into the junction tank (80), and the wash water can be fed to the release unit (30, 90, 95).

### BRIEF DESCRIPTION OF THE DRAWINGS

FIG. 1 is a schematic perspective view illustrating an entire configuration of an oral cleaning device according to a first embodiment.

FIG. 2 is a schematic block diagram illustrating the entire configuration of the oral cleaning device according to the first embodiment.

FIG. 3 is an enlarged schematic block diagram of an electrical discharge unit.

FIG. 4 is a top view of an insulation case.

FIG. 5 is a schematic perspective view illustrating an entire configuration of an oral cleaning device according to a second embodiment.

FIG. 6 is a block diagram illustrating the entire configuration of the oral cleaning device according to the second embodiment.

FIG. 7 is a schematic perspective view illustrating an entire configuration of an oral cleaning device according to a first variation.

FIG. 8 is a schematic perspective view illustrating an entire configuration of an oral cleaning device according to a second variation.

FIG. 9 is a schematic longitudinal cross-sectional view illustrating an entire configuration of an oral cleaning device according to a third variation.

### DESCRIPTION OF EMBODIMENTS

Embodiments of the present invention will be described hereinafter in detail with reference to the drawings. The following embodiments are set forth merely for the purposes of preferred examples in nature, and are not intended to limit the scope, applications, and use of the invention.

### First Embodiment of the Invention

An oral cleaning device (10) according to a first embodiment of the present invention is configured to sterilize the inside of a user's oral cavity by cleaning the oral cavity. In the oral cleaning device (10) of this embodiment, wash water containing hydrogen peroxide (H₂O₂) is used as wash water to be fed into the oral cavity.

<Entire Configuration of Oral Cleaning Device>

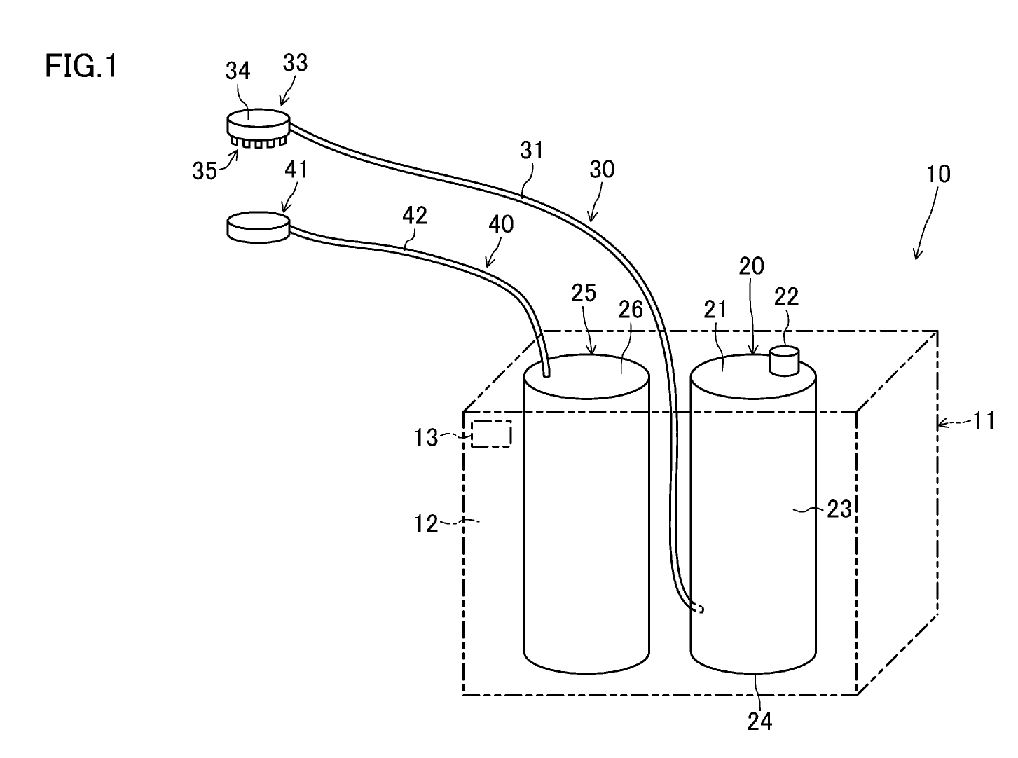

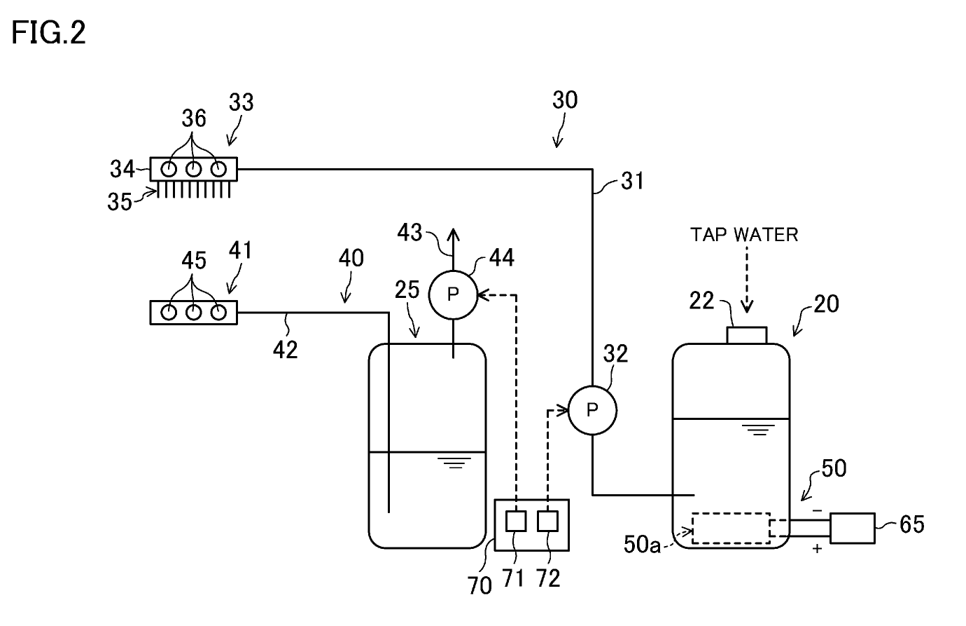

The entire configuration of the oral cleaning device (10) will be described with reference to FIGS. 1 and 2. The oral cleaning device (10) includes a casing (11), and a wash water production tank (20) and a discharge water tank (25) both housed in the casing (11).

The casing (11) is formed by a hollow box container which is thin in a front/back direction. The casing (11) is made of an opaque resin or a resin opacified by being colored, and the opaque resin or the resin opacified by being colored is selected from: polyether, such as polyphenylene oxide; polyester, such as polyethylene terephthalate or polybutylene terephthalate; polyacetal; an acrylic resin, such as polymethyl methacrylate; a styrenic resin, such as an ABS resin or high-impact styrene; a polyolefin resin, such as poly-2-methylpentene or polypropylene; and a polycarbonate resin.

A front surface (12) of the casing (11) includes an operation panel (13) for operating the oral cleaning device (10). The operation panel (13) includes an on/off switch for a main power supply, and operation switches (not shown).

Wash water to be fed into an oral cavity is stored in the wash water production tank (20). The wash water production tank (20) is formed in the shape of a vertically oriented hollow cylinder. A feed water inlet (22) through which the wash water production tank (20) is to be replenished with tap water is formed in a top portion (21) of the wash water production tank (20). Discharge water discharged from the inside of the oral cavity is stored in the discharge water tank (25). The discharge water tank (25) is formed in the shape of a vertically oriented hollow cylinder.

The oral cleaning device (10) includes a water feed mechanism (30) for feeding the wash water into the oral cavity. The water feed mechanism (30) includes a water feed tube (31), a water feed pump (32), and a brush unit (33).

The water feed tube (31) forms a water feed channel through which the wash water in the wash water production tank (20) flows. The water feed tube (31) is a flexible tube, and is made of, for example, a fluorocarbon resin material or a silicon material. One end portion (inlet end portion) of the water feed tube (31) is connected to a portion of an outer circumferential wall (23) of the wash water production tank (20) near a bottom portion (24) of the wash water production tank (20). The water feed tube (31) passes through the outer circumferential wall (23) of the wash water production tank (20) to communicate with the interior of the wash water production tank (20).

The water feed pump (32) (not shown in FIG. 1) is provided within the water feed tube (31). The water feed pump (32) forms a carrier for carrying the wash water in the wash water production tank (20) through the water feed tube (31) to the brush unit (33).

The brush unit (33) is connected to an outlet end of the water feed tube (31). The brush unit (33) forms a release unit configured to release the wash water into the oral cavity. The brush unit (33) includes a main body (34), and a brush (35) formed on the surface of the main body (34). The main body (34) includes a plurality of outlets (36) communicating with the water feed tube (31). The wash water is fed through the outlets (36) into the oral cavity. The brush (35) is formed by implanting a plurality of fibers into the main body (34). The brush (35) is used to brush, e.g., the inside of the oral cavity and teeth.

The oral cleaning device (10) includes a drain mechanism (40) configured to discharge the wash water fed into the oral cavity, as discharge water, to outside the oral cavity. The drain mechanism (40) includes a suction unit (41), a drain tube (42), an air suction pipe (43), and an air pump (44).

A plurality of suction ports (45) are formed in the suction unit (41) to communicate with the drain tube (42). The wash water in the oral cavity is discharged through the suction ports (45) to the outside.

The drain tube (42) forms a drain channel through which the discharge water flowing out of the oral cavity flows. The drain tube (42) is a flexible tube preferably made of a thermoplastic resin, and is made of, for example, a fluorocarbon resin material or a silicon material. One end portion (inlet end portion) of the drain tube (42) is connected to the suction unit (41). The other end portion (outlet end portion) of the drain tube (42) is connected to a top portion (26) of the discharge water tank (25). The drain tube (42) passes through the top portion (26) of the discharge water tank (25) to communicate with the interior of the discharge water tank (25).

The air suction pipe (43) is connected to the top portion (26) of the discharge water tank (25). The air suction pipe (43) passes through the top portion (26) of the discharge water tank (25) to communicate with the interior of the discharge water tank (25). In the discharge water tank (25), an opening of the air suction pipe (43) at the beginning of the air suction pipe (43) is located near the top portion (26) of the discharge water tank (25).

The air pump (44) is connected to the air suction pipe (43). The air pump (44) forms an air bleeding mechanism configured to place the interior of the discharge water tank (25) under negative pressure by sucking air in the discharge water tank (25). When the interior of the discharge water tank (25) is placed under negative pressure, discharge water from the oral cavity is suctioned with the suction unit (41).

The oral cleaning device (10) includes a controller (70) configured to control the water feed mechanism (30) and the drain mechanism (40). Specifically, the controller (70) includes, for example, a CPU, such as a microcomputer, a control program for the entire device executed by the CPU, a ROM in which various data are stored, and a RAM which serves as a work area, and in which measurement data and various data are temporarily stored. The controller (70) includes a timer setter (71), and a pump controller (72).

In the timer setter (71), for example, a water feed time Ts and a drain time Td are set. The water feed time Ts is the time during which the wash water is fed into the oral cavity by the water feed mechanism (30). The drain time Td is the time during which the wash water is discharged from the inside of the oral cavity by the drain mechanism (40). The water feed time Ts and the drain time Td are set at, for example, about several seconds.

The pump controller (72) controls the on/off operation of each of the water feed pump (32) and the air pump (44) based on a corresponding one of the water feed time Ts and the drain time Td. More specifically, the pump controller (72) of this embodiment controls the water feed pump (32) and the air pump (44) based on the water feed time Ts and the drain time Td, respectively, to alternately operate the pumps (32) and (44). In other words, in the oral cleaning device (10), after the lapse of the water feed time Ts from the start of operation of the water feed pump (32), the water feed pump (32) stops, and simultaneously, the air pump (44) is operated. Then, after the lapse of the drain time Td from the start of operation of the air pump (44), the air pump (44) stops, and simultaneously, the water feed pump (32) is again operated. Thus, in the oral cleaning device (10), a water feed operation in which the wash water is fed into the oral cavity, and a drain operation in which the wash water is discharged from the inside of the oral cavity are alternately performed each for the time set in the timer setter (71).

<Configuration of Electrical Discharge Unit>

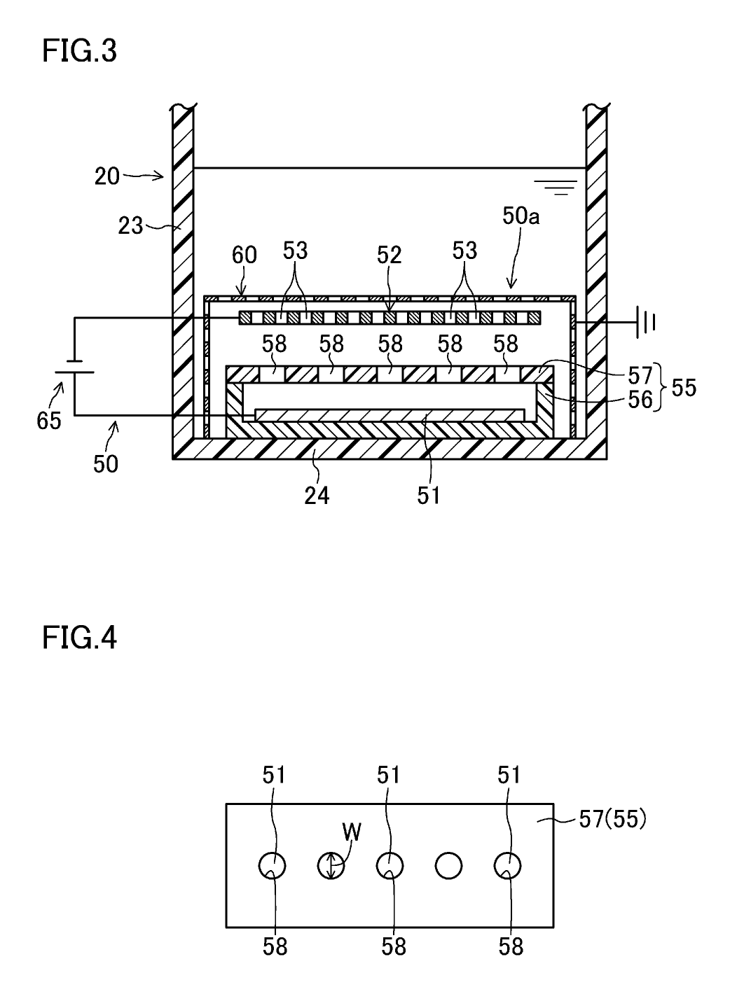

As illustrated in FIGS. 3 and 4, the oral cleaning device (10) includes an electrical discharge generator (50) for performing streamer discharge in water in the wash water production tank (20). The electrical discharge generator (50) has an electrical discharge unit (50a) and a direct-current power supply (65). The electrical discharge unit (50a) is disposed in a portion of the wash water production tank (20) near the bottom portion (24) thereof. The electrical discharge unit (50a) has a pair of electrodes (51, 52), an insulation case (55), and an earth cover (60).

The pair of electrodes (51, 52) includes an electrical discharge electrode (51) and a counter electrode (52). The electrical discharge electrode (51) is a plate-shaped electrode, and the counter electrode (52) is a mesh-like electrode having a plurality of holes (53). The counter electrode (52) may be formed in the shape of a plate in a manner similar to that of the electrical discharge electrode (51). The electrical discharge electrode (51) and the counter electrode (52) are opposed to each other so as to be parallel to each other while being each maintained in a horizontal position. The electrical discharge electrode (51) is connected to a positive terminal of the direct-current power supply (65), and the counter electrode (52) is connected to a negative terminal of the direct-current power supply (65). When a voltage is applied from the direct-current power supply (65) to the pair of electrodes (51, 52), streamer discharge is performed between the electrodes (51, 52). Thus, active species, such as hydroxyl radicals, are produced in the water, and furthermore, hydrogen peroxide is produced therein. Since the counter electrode (52) has the plurality of holes (53), this accelerates the diffusion of the produced hydrogen peroxide.

The insulation case (55) is placed on the bottom portion (24) of the wash water production tank (20). The insulation case (55) is an insulating member made of an insulating material, such as ceramic. The insulation case (55) is formed as an insulative container, and surrounds only one (51) of the pair of electrodes (51, 52). Specifically, the insulation case (55) has a container member (56) and a lid member (57). The container member (56) is formed as a box having one opened side (upper side). The electrical discharge electrode (51) is laid on the bottom of the container member (56). The lid member (57) blocks the opened upper side of the container member (56).

The lid member (57) has a plurality of openings (58) vertically passing through the lid member (57). In other words, the plurality of openings (58) are formed in an upper portion of the insulation case (55) (near the counter electrode (52)). In this embodiment, five openings (58) are spaced at regular intervals. The number of the openings (58) is merely an example, and as long as at least one opening (58) is formed, the number of the openings (58) may be any number. The openings (58) are each circular. The width (diameter) W of each of the openings (58) is preferably greater than or equal to 0.02 mm and equal to or less than 0.5 mm.

While the electrical discharge electrode (51) is surrounded by the insulation case (55), the plurality of openings (58) allow electrical discharge from the electrical discharge electrode (51) to the counter electrode (52). Thus, the insulation case (55) functions as a current density concentration member serving to increase the current density in each of current paths between the pair of electrodes (51, 52). Specifically, while the electrical discharge electrode (51) is surrounded by the insulation case (55), the current path during streamer discharge is narrowed by the plurality of openings (58). This increases the current density in the vicinity of each of the openings (58). This increases the amount of active species produced during streamer discharge and thus the amount of hydrogen peroxide produced.

A predetermined distance is kept between the electrical discharge electrode (51) and the lid member (57) in the insulation case (55). This improves the durability of the lid member (57). Specifically, when the electrical discharge electrode (51) and the lid member (57) are brought into close contact with each other, Joule heat incident to electrical discharge tends to melt or degrade the lid member (57). On the other hand, when a predetermined distance is kept between the electrical discharge electrode (51) and the lid member (57), this can reduce a sudden increase in the temperature of the lid member (57). Consequently, the melting or degradation of the lid member (57) due to electrical discharge is reduced.

The earth cover (60) accommodates the electrical discharge electrode (51), the counter electrode (52), and the insulation case (55). The earth cover (60) is a grounded net-like cover made of metal. This reduces the flow of electrical discharge current through the outside of the earth cover (60). Since the earth cover (60) is net-like, hydrogen peroxide produced inside the earth cover (60) diffuses to outside the earth cover (60).

The direct-current power supply (65) forms a power supply serving to apply a high direct-current voltage to the pair of electrodes (51, 52). The power supply voltage of the direct-current power supply (65) is set to several kilovolts or lower (e.g., 7 kV or lower). As such, since the power supply is the direct-current power supply (65), this can provide a simpler power supply having a smaller size at lower cost than when the power supply is, e.g., a pulse power supply serving to apply a pulse voltage. Such a pulse power supply tends to cause a shock wave and noise in water due to electrical discharge; however, when the power supply is the direct-current power supply (65), such a shock wave can also reduce noise generation.

In contrast, unlike the pulse power supply, the direct-current power supply (65) does not serve to instantaneously apply a large voltage, and thus, tends to increase the leakage current between the pair of electrodes (51, 52). However, when the electrical discharge electrode (51) is surrounded by the insulation case (55), this reduces the leakage current, resulting in an increase in the current density in the current path through each of the openings (58). Joule heat is generated in the opening (58) due to an increase in the current density, and thus, water in the opening (58) is vaporized to form air bubbles. The air bubbles function as resistances for reducing the leakage current between the pair of electrodes (51, 52). In view of the above, in the electrical discharge generator (50) of this embodiment, the leakage current between the pair of electrodes (51, 52) is minimized. This ensures a desired potential difference between the pair of electrodes (51, 52), and thus, streamer discharge is performed. The streamer discharge is performed in air bubbles formed in the vicinity of the openings (58).

The electrical discharge generator (50) includes a constant power controller (not shown) for controlling the discharged power during streamer discharge to a constant power. Such a constant power control enables streamer discharge at a constant discharged power even with a change in the electrical conductivity of the wash water due to the influence of, e.g., operation conditions. This can prevent the consumed power from being increased due to an excessively high discharged power under relatively high electrical conductivity, and furthermore, can prevent the amount of hydrogen peroxide produced from excessively decreasing due to an excessively low discharged power under relatively low electrical conductivity.

—Operational Behavior—

The operational behavior of the oral cleaning device (10) will be described. When operation of the oral cleaning device (10) is started, a voltage is applied from the direct-current power supply (65) to the pair of electrodes (51, 52). Thus, streamer discharge proceeds from the electrical discharge electrode (51) to the counter electrode (52). In this case, the electrical discharge path is narrowed between the pair of electrodes (51, 52) by each of the openings (58) of the insulation case (55), and thus, the current density in the vicinity of the opening (58) is concentrated. This enables the production of a high concentration of active species in water in the wash water production tank (20).

When active species, such as hydroxyl radicals, are produced in the wash water production tank (20), the active species react with water molecules to produce hydrogen peroxide. As a result, wash water having a desired hydrogen peroxide concentration is obtained in the wash water production tank (20). The hydrogen peroxide concentration in the wash water in the wash water production tank (20) is adjusted, for example, by detecting the hydrogen peroxide concentration in the wash water with a sensor, and turning the direct-current power supply (65) on or off to allow the detected hydrogen peroxide concentration to be closer to a predetermined target value, or by controlling the power output from the direct-current power supply (65) to the pair of electrodes (51, 52).

Under the circumstances, when the water feed pump (32) starts working to start a water feed operation, the wash water in the wash water production tank (20) is fed through the water feed tube (31) to the brush unit (33). The wash water fed to the brush unit (33) is released through the outlets (36) of the main body (34) into the oral cavity. Thus, while the inside of the oral cavity is wetted, the inside of the oral cavity is cleaned and sterilized. More specifically, a biofilm formed on the inside of the oral cavity is degraded.

After the lapse of a predetermined time (the water feed time Ts) from the start of the water feed operation, the water feed pump (32) stops. At the same time, the air pump (44) starts working to start a drain operation. In the drain operation, the wash water utilized to clean and sterilize the inside of the oral cavity is suctioned, as discharge water, into the suction ports (45) of the suction unit (41). The discharge water flows through the drain tube (42) into the discharge water tank (25), and is stored in the discharge water tank (25). After the lapse of a predetermined time (the drain time Td) from the start of the drain operation, the air pump (44) stops, and the water feed pump (32) is simultaneously operated. As described above, in the oral cleaning device (10), the operation in which the wash water is fed into the user's oral cavity, and the operation in which the wash water is discharged from the user's oral cavity to the outside are alternately executed.

### Advantages of First Embodiment

In the first embodiment, streamer discharge is performed in the water in the wash water production tank (20) to produce hydrogen peroxide. This eliminates the need for appropriately adding a hydrogen peroxide solution into the wash water production tank (20), and can automatically provide wash water containing hydrogen peroxide. The streamer discharge allows the rate of production of hydrogen peroxide to be much higher than that through, e.g., electrolysis. Specifically, the streamer discharge of the first embodiment allows the rate of production of hydrogen peroxide to be about 10 times as high as that through electrolysis. Therefore, in the first embodiment, a large amount of hydrogen peroxide is produced in a short time, thereby enhancing the effectiveness of oral cleaning and oral sterilization.

In the first embodiment, the direct-current power supply (65) is used as a power supply of the electrical discharge generator (50). This can provide a simpler power supply having a smaller size at lower cost than when a pulse power supply is used. The use of a pulse power supply tends to increase the intensity of a shock wave and noise generated in water due to electrical discharge. In contrast, the use of the direct-current power supply (65) can reduce the intensity of such a shock wave and such noise.

In the first embodiment, the brush unit (33) including the brush (35) is used as a release unit. Therefore, for example, a biofilm or plaque deposited on the inside of the oral cavity can be removed using the brush (35).

In the first embodiment, the water feed operation in which the wash water is fed into the oral cavity, and the drain operation in which the wash water in the oral cavity is discharged are alternately performed. Therefore, the wash water in the oral cavity can be sequentially replaced, thereby further enhancing the effectiveness of oral cleaning and oral sterilization. Furthermore, since the drain operation is performed, this can prevent the wash water accumulated in the oral cavity from overflowing the oral cavity.

In the first embodiment, the insulation case (55) is disposed to expose portions of the electrical discharge electrode (51) through the openings (58) to the outside. Therefore, the current path between the electrical discharge electrode (51) and the counter electrode (52) is narrowed by each of the openings (58) of the lid member (57). Since the current density is consequently concentrated in the vicinity of the opening (58), the streamer discharge is stabilized. Thus, hydrogen peroxide can be stably produced in the wash water production tank (20).

### Second Embodiment of the Invention

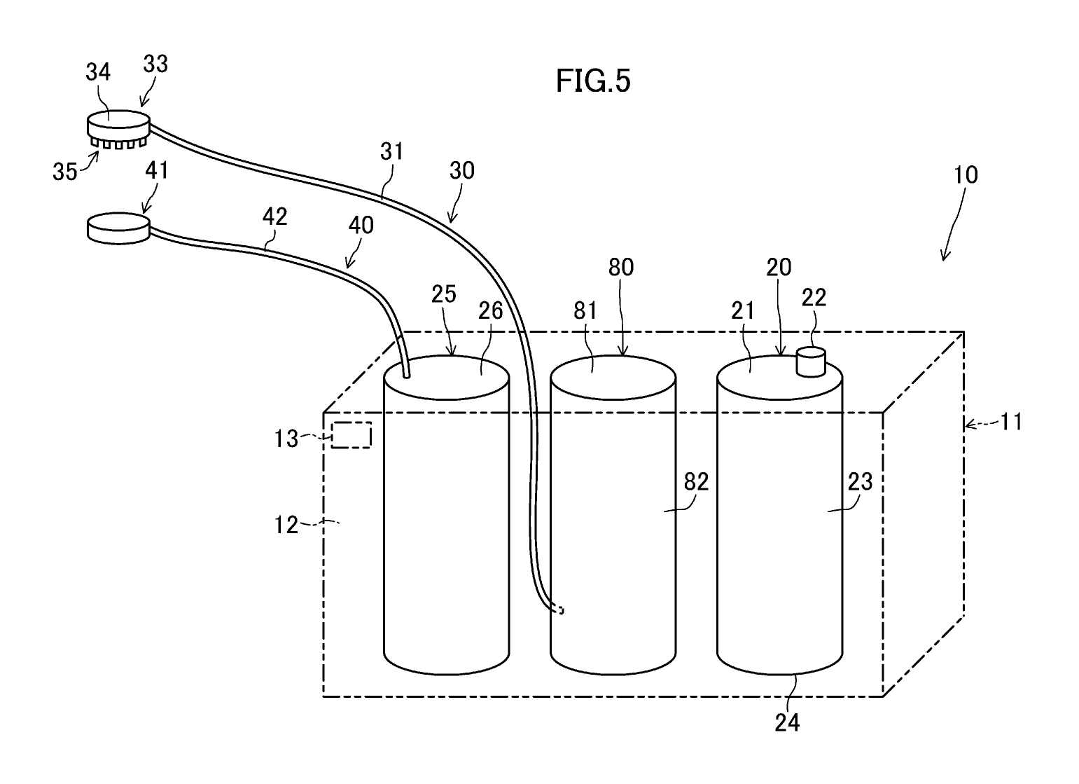

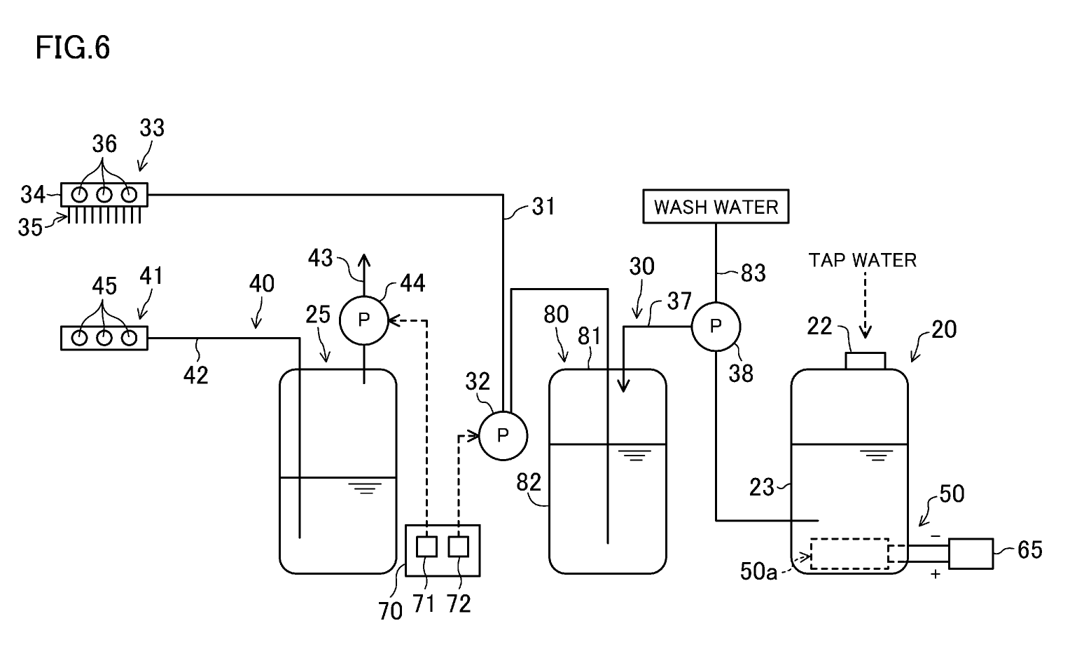

An oral cleaning device (10) according to a second embodiment is obtained by adding a junction tank (80) to the oral cleaning device (10) of the first embodiment. More specifically, in a water feed mechanism (30) of the second embodiment illustrated in FIGS. 5 and 6, a junction channel (37), the junction tank (80), and a water feed tube (31) are connected together in sequential order from near a wash water production tank (20) to near a brush unit (33).

One end portion (inlet end portion) of the junction channel (37) passes through an outer circumferential wall (23) of the wash water production tank (20) to communicate with the interior of the wash water production tank (20). The other end portion (outlet end portion) of the junction channel (37) passes through a top portion (81) of the junction tank (80) to communicate with the interior of the junction tank (80). The water feed tube (31) similar to that in the first embodiment is connected to an outer circumferential wall (82) of the junction tank (80). A junction pump (38) is connected to the junction channel (37), and a water feed pump (32) is connected to the water feed tube (31). The junction pump (38) of the second embodiment is connected also to a wash water feed line (83) through which predetermined wash water is fed. A different type of wash water from the wash water prepared in the wash water production tank (20) is fed through the wash water feed line (83).

To be specific, examples of cleaning agents added through the wash water feed line (83) into the junction tank (80) include medications, such as hexidine gluconate, benzethonium chloride, benzalkonium chloride, and azulene sodium sulfonate, glycols, such as propylene glycol, butylene glycol, and diethylene glycol, essential oils, such as menthol, mentha oil, and peppermint oil, honey, hyaluronic acid, a composition containing a xanthone derivative, and a green tea extract. These examples are ingredients from which antimicrobial activity, bad breath prevention, and anti-inflammatory activity are expected, and an effect obtained by combining the ingredients and hydrogen peroxide together can be also expected.

In the oral cleaning device (10) of the second embodiment, appropriate operation of the junction pump (38) allows the wash water in the wash water production tank (20) to flow through the junction pump (38), and then to be appropriately fed into the junction tank (80). In the second embodiment, other types of wash water can be also appropriately fed through the wash water feed line (83).

The other operations are similar to those in the first embodiment. Specifically, in a water feed operation, the wash water in the junction tank (80) is carried through the water feed tube (31) to the brush unit (33), and the wash water is released through the brush unit (33) into an oral cavity. After the completion of the water feed operation, a drain operation is performed, and the wash water in the oral cavity is recovered through a drain tube (42) into a discharge water tank (25).

### Advantages of Second Embodiment

Also in the second embodiment, streamer discharge is performed in water in the wash water production tank (20) to produce hydrogen peroxide as in the first embodiment. This eliminates the need for appropriately adding a hydrogen peroxide solution into the wash water production tank (20), and can automatically provide wash water containing hydrogen peroxide. The streamer discharge enables the production of hydrogen peroxide at a very high production rate.

In the second embodiment, the junction tank (80) is provided between the wash water production tank (20) and the brush unit (33). This can ensure a sufficient amount of the wash water which is fed into the oral cavity, thereby stably feeding the wash water into the oral cavity.

### Other Embodiments

In the first and second embodiments described above, other configurations described below can be used.

<Configurations of Release Unit and Suction Unit>

In each of the embodiments described above, the brush unit (33) is used as a release unit configured to release wash water into an oral cavity; however, any other configurations may be used as the release unit.

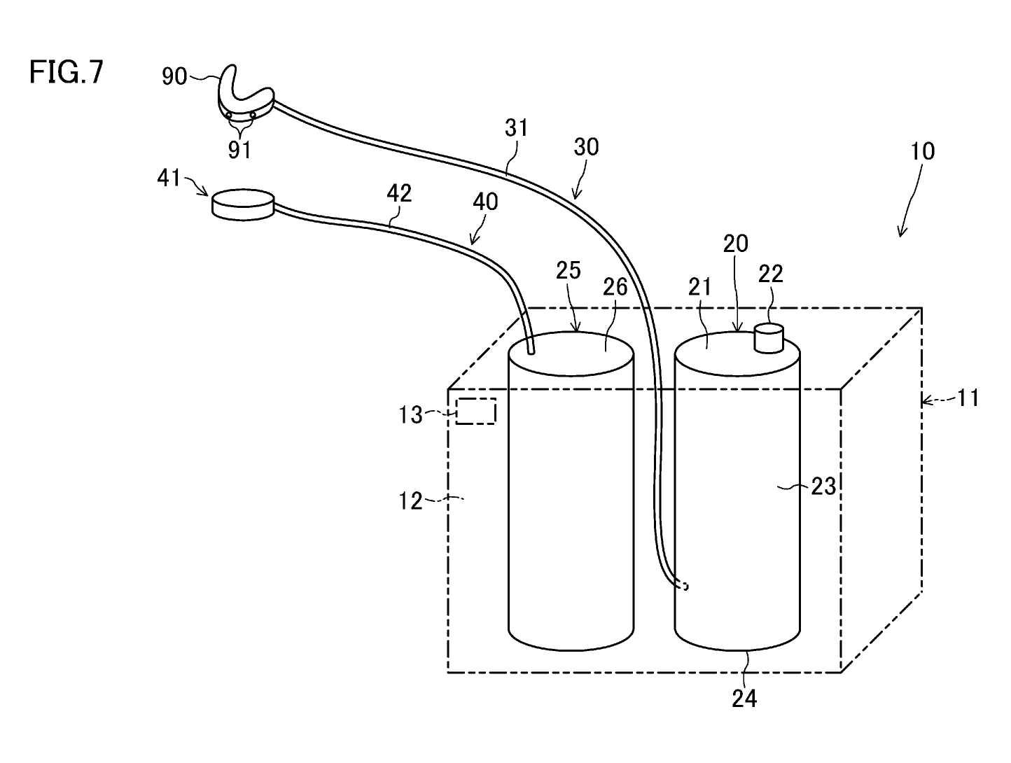

In an example (first variation) illustrated in FIG. 7, a mouthpiece (90) is used as a release unit configured to release wash water into an oral cavity. The mouthpiece (90) is formed so as to be in close contact with a gingiva, and includes a plurality of outlets (91) communicating with the water feed tube (31). In the first variation, when the mouthpiece (90) is inserted into the oral cavity, the wash water can be fed to the gingiva. Furthermore, when the mouthpiece (90) is bitten hard, this strengthens lips and facial muscles.

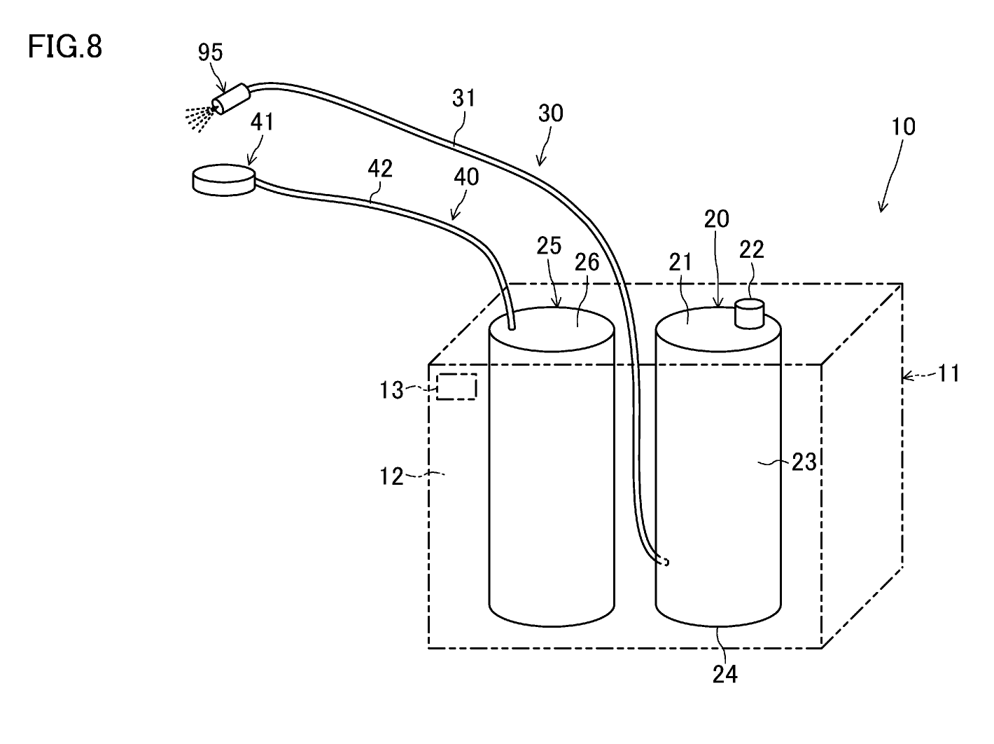

In an example (second variation) illustrated in FIG. 8, a spray (95) is used as a release unit configured to release wash water into an oral cavity. Wash water is fed in the form of mist through the spray (95) into the oral cavity. Thus, the wash water is relatively uniformly and relatively widely fed into the oral cavity. This can enhance the effectiveness of oral cleaning and oral sterilization.

The release units (33, 90, 95) described above are each preferably removably attached to the water feed tube (31). Thus, each of the release units (33, 90, 95) can be appropriately replaced, thereby maintaining oral health. Similarly, the suction unit (41) is also preferably removably attached to the drain tube (42).

Each of the release units (33, 90, 95) described above and the suction unit (41) are separately formed; however, the release unit (33, 90, 95) and the suction unit (41) may be unitized by being integrally connected together.

<Type of Wash Water>

In each of the embodiments described above, water is added into the wash water production tank (20), and streamer discharge is performed in the water in the wash water production tank (20) to produce hydrogen peroxide. However, a saline solution may be added into the water in the wash water production tank (20). When streamer discharge is performed in wash water containing a saline solution, water containing salt (water to be electrolyzed) is electrolyzed to produce hypochlorous acid (HClO). The hypochlorous acid shows greater bacteriocidal acitivity than hydrogen peroxide, thereby further enhancing the effectiveness of oral sterilization using the wash water.

Not only the hypochlorous acid, but also a mild sanitizer or a tea component (such as catechins) for improving the aftertaste in the oral cavity after oral cleaning may be added into the wash water.

<Water Feed Operation and Drain Operation>

In each of the embodiments described above, a drain operation starts at the same time as the completion of a water feed operation, and a water feed operation starts at the same time as the completion of the drain operation; in this manner, water feed operations and drain operations are alternately performed. However, a water feed operation and a drain operation may be simultaneously performed. Alternatively, a drain mechanism (40) may be omitted, and only a water feed operation may be executed. In this case, a user may appropriately eject the wash water accumulated in the oral cavity.

<Formation of Hydrogen Peroxide Solution>

In each of the embodiments described above, streamer discharge is controlled such that a value detected with a hydrogen peroxide sensor becomes closer to a target value, thereby obtaining wash water having a desired hydrogen peroxide concentration. However, the hydrogen peroxide sensor may be omitted, and streamer discharge may be performed only for a predetermined set time. This set time is empirically determined to obtain wash water having a desired hydrogen peroxide concentration, and may be, for example, a value varying depending on the amount of tap water added.

<Configuration of Electrical Discharge Unit>

In each of the embodiments described above, the constant power controller is used to control the discharged power during streamer discharge to a constant power. However, instead of the constant power controller, a constant current controller can be provided to control the discharged current during streamer discharge to a constant current. The control of the discharged current to a constant current allows electrical discharge to be stable independently of the electrical conductivity of the wash water, thereby preventing sparks.

In each of the embodiments described above, the electrical discharge electrode (51) is connected to the positive terminal of the direct-current power supply (65), and the counter electrode (52) is connected to the negative terminal of the direct-current power supply (65). However, so-called negative discharge may be performed between the electrodes (51, 52) by connecting the electrical discharge electrode (51) to the negative terminal of the direct-current power supply (65), and connecting the counter electrode (52) to the positive terminal of the direct-current power supply (65).

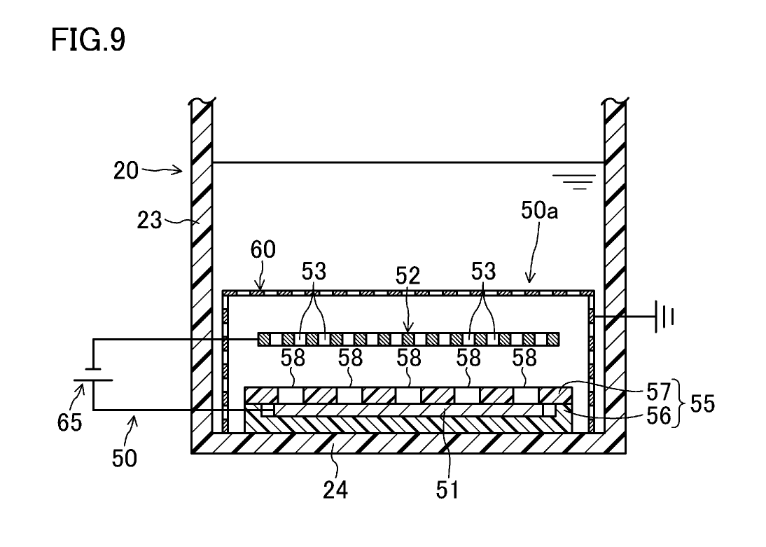

In each of the embodiments described above, as illustrated in an example (third variation) in FIG. 9, the insulative lid member (57) and the electrical discharge electrode (51) may be in contact with each other. This configuration also enables the concentration of the current density in the vicinity of each of the openings (58) of the lid member (57). Therefore, stable streamer discharge is performed, thereby accelerating the rate of production of hydrogen peroxide.

### INDUSTRIAL APPLICABILITY

As described above, the present invention is useful for oral cleaning devices configured to clean the inside of an oral cavity.

### Description of Reference Characters

10 ORAL CLEANING DEVICE
20 WASH WATER FORMATION TANK (TANK)
30 WATER FEED MECHANISM
31 WATER FEED TUBE (WATER FEED CHANNEL)
32 WATER FEED PUMP (CARRIER)
33 BRUSH UNIT (RELEASE UNIT)
34 MAIN BODY
35 BRUSH
36 OUTLET
40 DRAIN MECHANISM
41 SUCTION UNIT
50 ELECTRICAL DISCHARGE GENERATOR
50a ELECTRICAL DISCHARGE UNIT
51 ELECTRICAL DISCHARGE ELECTRODE (PAIR OF ELECTRODES)
52 COUNTER ELECTRODE (PAIR OF ELECTRODES)
55 INSULATION CASE (CURRENT DENSITY CONCENTRATION MEMBER)
56 CONTAINER MEMBER
57 LID MEMBER
58 OPENING
65 DIRECT-CURRENT POWER SUPPLY (POWER SUPPLY)
70 CONTROLLER
90 MOUTHPIECE (RELEASE UNIT)
95 SPRAY (RELEASE UNIT)

1. An oral cleaning device, comprising:
a wash water production tank in which wash water to be fed into an oral cavity is produced and stored;
a water feed mechanism including a water feed channel having one end connected to the wash water production tank, a carrier configured to carry the wash water in the wash water production tank into the water feed channel, and a release unit connected to an outlet end of the water feed channel to release the wash water into the oral cavity; and
an electrical discharge generator which includes a pair of electrodes for inducing streamer discharge in water in the wash water production tank, and a power supply configured to apply a voltage to the pair of electrodes, and is configured to produce hydrogen peroxide in the water by the streamer discharge.

2. The oral cleaning device of claim 1, wherein
the power supply is a direct-current power supply configured to apply a direct-current voltage to the pair of electrodes, and
the electrical discharge generator includes a current density concentration member configured to increase a current density in a current path between the pair of electrodes.

3. The oral cleaning device of claim 1 or 2, wherein
the release unit includes a main body having an outlet through which the wash water is released, and a brush formed on a surface of the main body.

4. The oral cleaning device of claim 1 or 2, wherein
the release unit includes a spray configured to spray the wash water.

5. The oral cleaning device of claim 1 or 2, further comprising:
a drain mechanism including a suction unit configured to suction the wash water in the oral cavity and discharge the wash water to an outside.

6. The oral cleaning device of claim 5, further comprising:
a controller configured to control the water feed mechanism and the drain mechanism to alternately perform a water feed operation in which the wash water is fed into the oral cavity and a drain operation in which the wash water is discharged from an inside of the oral cavity each for a predetermined time, or to simultaneously perform the water feed operation and the drain operation.

7. The oral cleaning device of claim 2, wherein
the current density concentration member is formed as an insulative container having at least one opening, and surrounds only one of the pair of electrodes.

8. The oral cleaning device of claim 1 or 2, wherein
in the water feed mechanism, a junction tank is connected to the water feed channel between the wash water production tank and the release unit. BIRCH, STEWART, KOLASCH & BIRCH, LLP DRA/DRA/thc
